(19) United States
(12) Patent Application Publication
(10) Pub. No.: US 2004/0003798 A1
(43) Pub. Date: Jan. 8, 2004

(54) Fuel injection unit

(76) Inventor: Jan Mutschler, Stein (DE)

Correspondence Address: KENYON & KENYON, ONE BROADWAY, NEW YORK, NY, 10004, US

(21) Appl. No.: 10/332,336

(22) PCT Filed: Apr. 18, 2002
(86) PCT No.: PCT/DE02/01433

(30) Foreign Application Priority Data
May 5, 2001 (DE) 101 21 884.2

(51) Int. Cl. F02M 1/00

(52) U.S. Cl. 123/470; 123/456

(57) ABSTRACT

A fuel injection system for injecting fuel into an internal combustion engine includes at least one fuel injector and a fuel-distributor line, which, for each fuel injector, is provided with a connecting piece that is able to be connected to an intake-side end of the fuel injector, one annular seal being provided in each case to sealingly join the fuel injector to the associated connecting piece of the fuel-distributor line. The connecting piece is formed in such a way that, following installation of the seal, the end of the connecting piece facing the fuel injector is able to be inserted into the inflow-side end of the fuel injector, a spring element being positioned between the connecting piece and an inner support surface of the fuel injector.

### FIELD OF THE INVENTION

The present invention relates to a fuel injection system for injecting fuel into an internal combustion engine, especially for the direct injection of fuel into the combustion chamber, or the combustion chambers, of the internal combustion engine.

### BACKGROUND INFORMATION

A fuel injection system is known from German Published Patent Application No. 197 25 076. To provide a sealing connection, the fuel injection system includes an annular sealing support between a fuel injector and an associated connecting piece of a fuel-distributor line, the sealing support cooperating with a first sealing element to seal the sealing support from an end face of an intake section of the fuel injector, and cooperating with a second sealing element to seal the sealing support from the connecting piece of the fuel-distributor line. A bushing, which can be inserted into a fuel-intake orifice of the intake section, penetrates the annular sealing support, thereby retaining the sealing support between an upstream collar of the bushing and the intake section of the fuel injector in a manner allowing movement in the radial direction.

A particular disadvantage of the system described in the aforementioned printed publication is that, because of the manufacturing tolerances of both the receiving bore for the fuel injector and also the connecting piece at the fuel-distributor line, positional deviations and angular deviations can occur between the intake section of the fuel injector, on the one hand, and the connecting piece of the fuel-distributor line, on the other hand. The seal positioned between the intake section of the fuel injector and the connecting piece of the fuel-distributor line compensates for the positional and angular deviations only to a limited, insufficient extent. In the positional and angular deviations that occur in practice, there is the danger in known fuel injection systems that fuel escapes at the seal where insufficient compensation for positional and angular deviations is provided.

### SUMMARY OF THE INVENTION

In contrast, the fuel injection system according to the present invention has the advantage over the related art that, by inserting the connecting piece into a recess of the fuel injector, a substantially space-saving connection is produced. A spring element disposed between the connecting piece of the fuel-distributor line and an intake connection piece of the fuel injector, is able to compensate for manufacturing tolerances, for tilting during installation of the fuel injector in the cylinder head, as well as for uneven warming during operation of the internal combustion engine, in an effective and space-saving manner.

It is advantageous that, depending on the prevailing holding-down forces, the spring element may be designed in different variants as a conical spring washer or helical spring.

Furthermore, it is advantageous that the fuel injectors are able to be preassembled at the fuel-distributor line with the aid of a holding clamp, thereby saving considerable time during the final assembly of the fuel injectors in the cylinder head.

The fuel-distributor line is advantageously screwed to the cylinder head, or connected to the cylinder head using hold-down devices or similar devices.

### BRIEF DESCRIPTION OF THE DRAWINGS

FIG. 1 shows a section through a first exemplary embodiment of a fuel injection system according to the present invention, in an overall view.

FIG. 2A shows a section through an individual fuel injector of the fuel injection system shown in FIG. 1.

FIG. 2B shows a second exemplary embodiment of a fuel injector designed according to the present invention, suited for installation in the fuel injection system.

### DETAILED DESCRIPTION

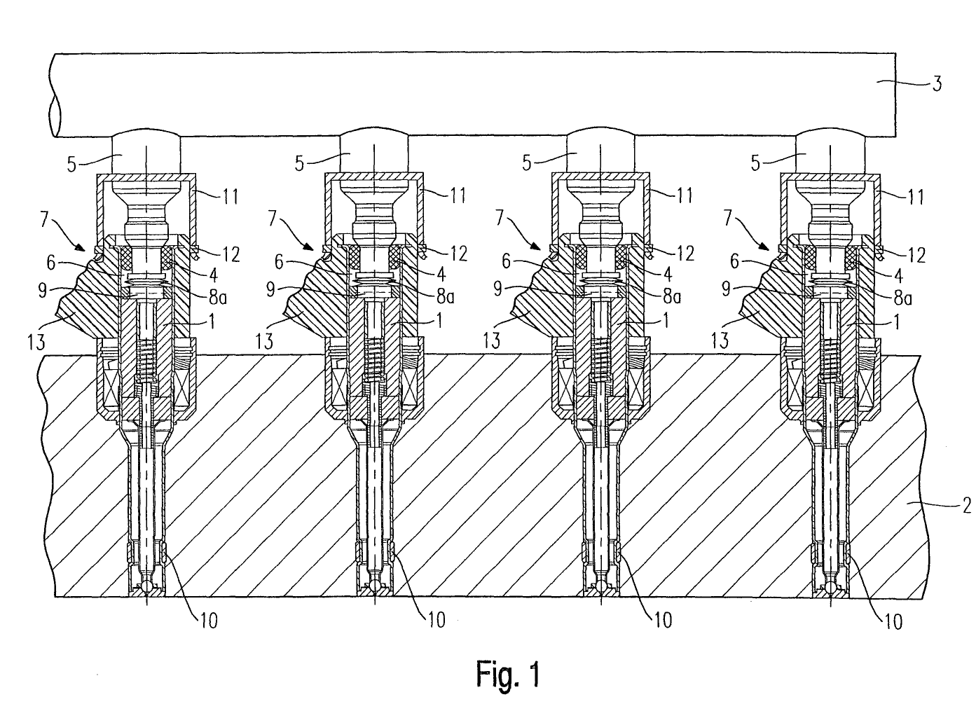

FIG. 1, in a schematic section, shows an overall view of a first exemplary embodiment of a fuel injection system designed according to the present invention, which, in the current exemplary embodiment, includes four fuel injectors 1. Fuel injectors 1, preferably in the form of high-pressure fuel injectors 1, are suited for the direct injection of fuel into the combustion chambers of a mixture-compressing internal combustion engine having external ignition. In the following, only those components are discussed that have a direct connection to the measures according to the present invention.

Fuel injectors 1 are installed in a series configuration in a cylinder head 2 of the internal combustion engine and are interconnected by a fuel-distributor line 3. The measures according to the present invention relate to the connection of fuel injectors 1 to fuel-distributor line 3.

Fuel injectors 1 are joined to fuel-distributor line 3 by seals 4, which are inserted into groove-type depressions at the outer circumference of connecting pieces 5 of fuel-distributor line 3. Connecting pieces 5 are designed to each be insertable into a recess 6 in inflow-side ends 7 of fuel injectors 1. A reliable sealing effect may be achieved between fuel-distributor line 3 and fuel injectors 1 by pinching seals 4.

In addition, a spring element 8 is provided in each case to transmit to fuel injectors 1 the pressure force of fuel-distributor line 3, which may be connected to cylinder head 2, for instance, by holding devices or clamps (not shown). In the present first exemplary embodiment, this spring element is designed as a conical spring washer 8a. Conical spring washers 8a are inserted between connecting pieces 5 of fuel-distributor line 3 and inner support surfaces 9 in recesses 6 of fuel injectors 1 and, by their initial stress, transmit the holding-down forces of fuel-distributor line 3, which is pulled to cylinder head 2 by holding devices, to fuel injectors 1, thereby pressing them into cylinder head 2. Sealing rings 10, which are pressed between fuel injectors 1 and cylinder head 2, may be provided to seal cylinder head 2 from the combustion chambers. Support surfaces 9 in recesses 6 are formed at supporting disks 14, for instance, which are disposed, for example, on the inner poles 15 of fuel injectors 1.

Holding clamps 11 are provided to attach connecting pieces 5 to fuel injectors 1; they are suited, in particular, for premounting fuel injectors 1 at fuel-distributor line 3, since the entire fuel injection system may then be installed as a whole in or at cylinder head 2. Holding clamps 11 reach around connecting pieces 5 of fuel-distributor line 3 and extend up to end 7 on the intake side of fuel injectors 1. There, they are preferably anchored by screws 12 in a plastic extrusion coating 13 of fuel injectors 1. Alternatively, projecting lips, which engage with openings of holding clamp 11, may be provided at plastic extrusion coating 13.

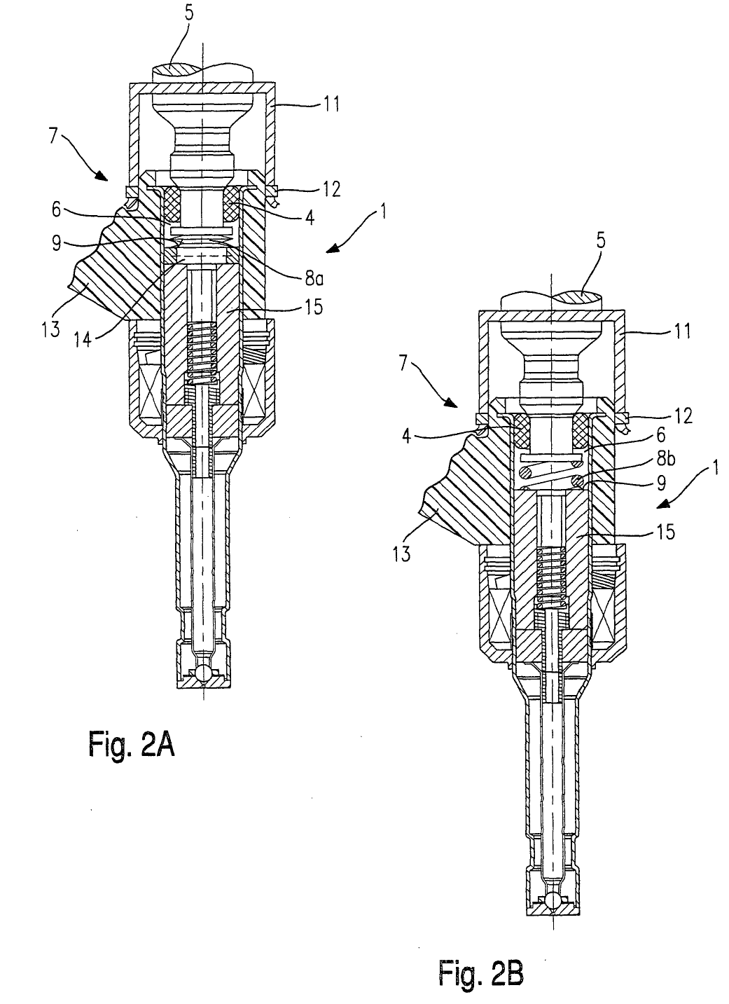

To illustrate the measures according to the present invention, FIG. 2A shows an individual fuel injector 1 into which connecting piece 5 of fuel-distributor line 3 has been inserted, and which includes holding clamp 11. Corresponding components are denoted by corresponding reference numerals.

As already explained in connection with FIG. 1, fuel injector 1 includes a spring element 8 between connecting piece 5 of fuel-distributor line 3 and supporting disk 14, which is designed as a conical spring washer 8a in the present exemplary embodiment. On the one hand, conical spring washer 8a transmits the holding-down forces of fuel-distributor line 3, and, on the other hand, makes it possible to compensate for misaligments and tilting of fuel injector 1, which may occur, for instance, as a result of manufacturing tolerances of the individual components, by a skewed installation of fuel injector 1 in cylinder head 2, or of warming of cylinder head 2 and fuel injector 1 during operation of the internal combustion engine. In this way, reliable sealing is achieved, on the one hand, of cylinder head 2 from the combustion chamber of the internal combustion engine and, on the other hand, of fuel injector 1 from fuel-distributor line 3.

FIG. 2B, in the same view as FIG. 2A, shows a second exemplary embodiment of a fuel injector 1 to be installed in the fuel injection system designed according to the present invention.

In the present second exemplary embodiment, spring element 8 is designed in the form of a helical spring 8b. It has the particular advantage of being easy to produce and of having greater flexibility compared to conical spring washer 8a, since conical spring washers 8a, in most cases, have a higher spring constant, especially when having small radii. Helical spring 8b allows for a more even compensation for misalignments and tilting. Helical spring 8b, for instance, is braced directly against inner pole 15 of fuel injector 1.

The present invention is not restricted to the exemplary embodiments shown and is also suited, for instance, for fuel injection systems of mixture-compressing internal combustion engines having self-ignition.

What is claimed is:

1. A fuel injection system for injecting fuel into an internal combustion engine having at least one fuel injector (1) and a fuel-distributor line (3) which, for each fuel injector (1), is provided with a connecting piece (5) that is able to be connected to an intake-side end (7) of the fuel injector (1), an annular seal (4) being provided in each case to sealingly join the fuel injector (1) to the associated connecting piece (5) of the fuel-distributor line (3), wherein the connecting piece (5) is formed in such a way that, following installation of the seal (4), the connecting piece (5), at the end of the connecting piece (5) facing the fuel injector (1), is insertable into the inflow-side end (7) of the fuel injector (1), a spring element (8) being positioned between the connecting piece (5) and an inner support surface (9) of the fuel injector (1).

2. The fuel injection system as recited in claim 1,
wherein the fuel-distributor line (3) is connected to a cylinder head (2) of the internal combustion engine.

3. The fuel injection system as recited in claim 1 or 2,
wherein the spring element (8) is designed in the form of a conical spring washer (8a).

4. The fuel injection system as recited in claim 1 or 2,
wherein the spring element (8) is designed in the form of a helical spring (8b).

5. The fuel injection system as recited in one of claims 1 through 4,
wherein each fuel injector (1) is able to be premounted at a connecting piece (5) of the fuel-distributor line (3) by using a holding clamp (11).

6. The fuel injection system as recited in claim 5,
wherein the holding clamp (11) is attached to a plastic extrusion coating (13) of the fuel injector (1) by screws (12) or clamps.

7. The fuel injector system as recited in claim 5,
wherein provision is made at a plastic extrusion coating (13) of the fuel injector (1) for at least one projecting lip, which engages with an opening of the holding clamp (11).

8. The fuel injection system as recited in one of claims 1 through 7,
wherein the fuel injectors (1) attached to the fuel-distributor line (3) are able to be simultaneously inserted into the cylinder head (2) of the internal combustion engine.

9. The fuel-injection system as recited in one of claims 1 through 4,
wherein the inner support surface (9) of the fuel injector (1) provided for the spring element (8) is provided at a supporting disk (14) or at an inner pole (15).
